(19) United States
(12) Patent Application Publication
(10) Pub. No.: US 2006/0148571 A1
(43) Pub. Date: Jul. 6, 2006

(54) Computer game with game saving including history data to allow for play reacquaintance upon restart of game

(75) Inventors: Paul Hossack, Vancouver (CA); David McCarthy, North Vancouver (CA)

Correspondence Address: TOWNSEND AND TOWNSEND AND CREW LLP/EA, TWO EMBARCADERO CENTER, 8TH FLOOR, SAN FRANCISCO, CA, 94111, US

(73) Assignee: Electronic Arts Inc., Redwood City, CA (US)

(21) Appl. No.: 11/099,220

(22) Filed: Apr. 4, 2005

Related U.S. Application Data
(60) Provisional application No. 60/641,623, filed on Jan. 4, 2005.

(51) Int. Cl. A63F 13/00

(52) U.S. Cl. 463/43

(57) ABSTRACT

In a computer game, game state is saved when indicated and a history of previous game play is also recorded. Upon resumption, the history of previous game play is presented to the user and the game does not accept user input to alter the replaying game sequence. Then, once the replay is at an end, the game resumes with user control and with the saved game state. In this manner, the user can be refamiliarized with the particular instance of the game that was saved before having to take control of the game. The games might be fantasy games, sports games, adventure games, or other types of games. In a specific embodiment, as the game is played, the events of the game are stored in a circular buffer of some determined time period. The determined time period might be user settable or set by the game designer based on memory available and the type of game. Thus, for example, a chess game might have a history comprising the last seven moves, while a soccer game might have a history comprising a buffer of the last five seconds of game play. In each case, the circular buffer would be such that at any time a game save is triggered the circular buffer contains the most recent history of the game. In the example of the soccer game, the history data in the buffer would be continually overwritten as that data comes to represent events that happened more than five seconds before the current time.

### CROSS-REFERENCES TO RELATED APPLICATIONS

This application claims the benefit of U.S. Provisional Application Ser. No. 60/641,623 (Attorney docket No. 019491-009900US), filed Jan. 4, 2005, the disclosure of which is incorporated herein by reference in its entirety.

### BACKGROUND OF THE INVENTION

The present invention relates generally to computer games and in particular to computer games that execute based on a game state and have features to allow a current game to be saved and resumed at a later time.

A computer game typically involves accepting user input, processing it according to game rules and game data and presenting the user with a display illustrating the output of the game process executed by the computer game. For example, with a particular game, the user input is accepted and translated into movements of a computer-generated character within a game space.

A game space might be geometrically modeled or provided for in some other manner. Where the computer game is a simulation of a real-world game, the model might map to the corresponding real-world game space. For example, for a computer game simulating a soccer game, user input is used to control one or more simulated players located on a simulated soccer field.

Game play can be determined, according to how the game is programmed, from a game state. Some computer games are video games, in that their output can be presented as a video signal, such as a 30 frame/second video (typical for interleaved NTSC video), 50 frame/second video (typical for noninterleaved PAL video) or 60 frame/second video (typical for noninterleaved video, such as might be used with computer monitors, game consoles and the like). With such systems, game state might be updated each frame, but game state can also be updated at different intervals, periodic or otherwise. In any case, it is typically possible for a game state to be known and recordable, such that a game can be saved (by saving its current state) for later resumption (by reading back the saved state and using that as the current game state).

Game state might include game variables, such as current game time, current level, position and direction of motion for each of a plurality of players, random seeds used to derive game actions, state of user input devices, scores, etc. In general, game state can comprise any data stored in computer memory that informs the game program about what to do next (e.g., what to display next, how to process inputs, etc.).

With the advent or ever more portable gaming systems, such as handheld devices accepting user input and providing a game display, more users will find themselves saving games for later resumption. For example, if a user is playing a game while waiting for a bus, the user might have to quickly save the game to catch the bus and then resume sometime later. Also, if the portable device is battery powered and the battery is running low, it might force a game save to avoid loss of game data.

It might be that considerable time elapses between the saving of a game and the resumption of a game, in which case the user might have trouble identifying a best move immediately following resumption of an ongoing game. An improvement in computer gaming would therefore be desirable to overcome the shortcomings of the prior art.

### BRIEF SUMMARY OF THE INVENTION

The present invention provides systems and methods for saving and replaying game history for a certain gameplay period prior to a game save event. The present invention allows a user to pause a game, or save a game, and resume playing at a later time with a replay of events occurring during the game just prior to the point in time in which the game was stopped being displayed so as to better acclimate the user to the gameplay environment.

In one embodiment of a computer game according to the present invention, game state is saved when indicated and a history of previous game play is also recorded. Upon resumption, the history of previous game play is presented to the user and the game does not accept user input to alter the replaying game sequence (except perhaps to pause, rewind or speed up the replay sequence). Then, once the replay is at an end, the game resumes with user control and with the saved game state. In this manner, the user can be refamiliarized with the particular instance of the game that was saved before having to take control of the game. An on-screen countdown timer may also be provided to better prepare the user for the moment that user control of the game resumes.

In some examples, the games are fantasy games, sports games, adventure games, or other types of games.

In a specific embodiment, as the game is played, the events of the game are stored in a circular buffer of some determined time period. The determined time period might be user settable or set by the game designer based on memory available and the type of game. Thus, for example, a chess game might have a history comprising the last seven moves, while a soccer game might have a history comprising a buffer of the last N seconds (e.g., five seconds) of game play. In each case, the circular buffer would be such that at any time a game save is triggered the circular buffer contains the most recent history of the game. In the example of the soccer game, the history data in the buffer would be continually overwritten as that data comes to represent events that happened more than N seconds before the current time.

According to one aspect of the present invention, a computer game system is provided that typically includes a user input module for receiving user input, at least one processor, and a display output module for outputting a game display, and wherein the output game display is at least in part dependent upon the received user input. The game system also typically includes game history storage for storing game events over a finite, nonzero time span, and means for replaying a game history using the stored game events upon loading of a saved game or resumption of a paused game and prior to turning over control of the game to the user.

According to another aspect of the present invention, a computer-implemented method is provided for refamiliarizing a user with game events occurring during gameplay of a computer game prior to a restart of a saved game configuration. The method typically includes storing game events over a finite, nonzero time span during gameplay, and receiving an instruction to save gameplay. The method also typically includes, in response to an instruction to resume gameplay, replaying at least a portion the stored game events on a display without allowing user input control of gameplay, and immediately thereafter returning game control to the user and resuming gameplay. The instruction to save may be automatically generated by the game logic or it may be generated in response to a user selection to save or pause the game. Similarly, the instruction to resume may be automatically generated by the game logic or it may be generated in response to a user selection to resume gameplay of a saved game configuration.

According to yet another aspect of the present invention, a computer readable medium is provided that includes code for controlling a processor to refamiliarize a user with game events occurring during gameplay of a computer game prior to a restart of a saved game configuration. The code typically includes instructions to store game events over a finite, nonzero time span during gameplay and to receive a command to save gameplay. The code also typically includes instructions to replay at least a portion the stored game events on a display, in response to a command to resume gameplay, without allowing user input control of gameplay, and to immediately thereafter return game control to the user and resume gameplay. The command to save may be automatically generated by the game logic or it may be generated in response to a user selection to save or pause the game. Similarly, the command to resume may be automatically generated by the game logic or it may be generated in response to a user selection to resume gameplay of a saved game configuration.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates a game system for providing one or more games for a user according to embodiments of the present invention.

FIG. 2 illustrates an embodiment of a game device according to the present invention that forms part of the game system shown in FIG. 1.

FIG. 3 illustrates an example of game data that might form part of a game state and game history.

FIG. 4 is a flowchart of one possible process for game replay.

### DETAILED DESCRIPTION OF THE INVENTION

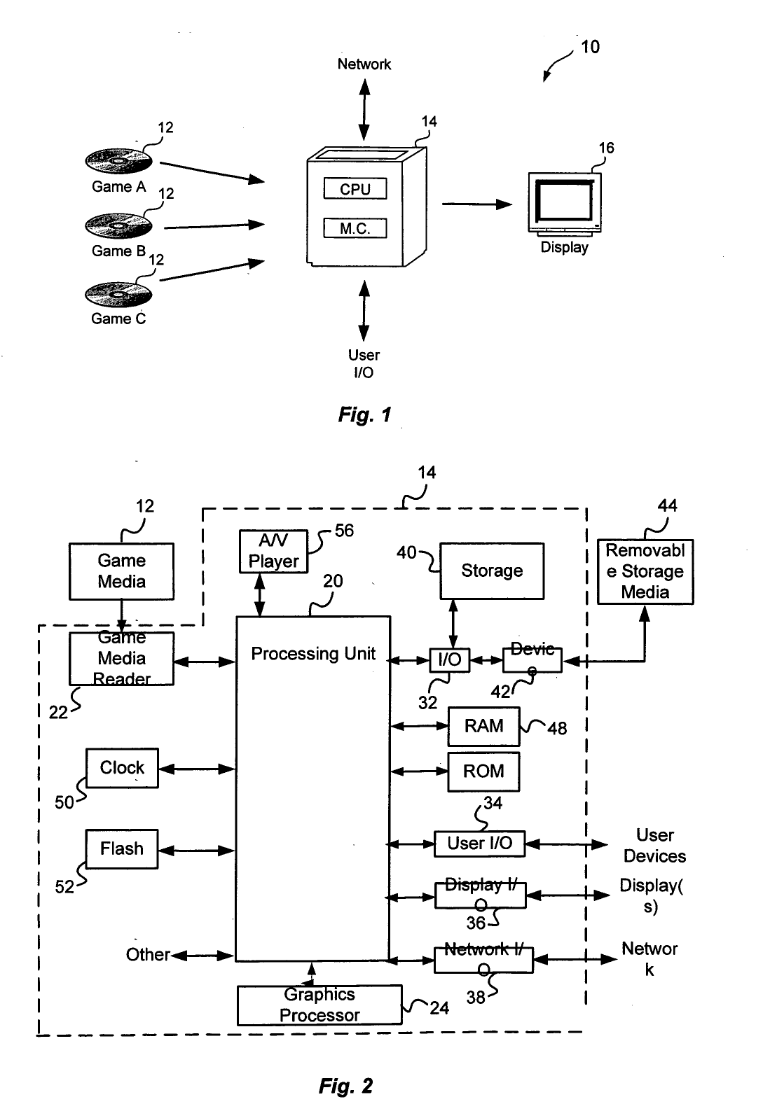

FIG. 1 illustrates a game system 10 for providing one or more games for a user according to embodiments of the present invention. System 10 is shown including one or more game media 12 (game A, game B, game C), a game device 14, and a display 16.

One or more game media 12 can include any game applications that may be used by game device 14 to involve a user in a game. Each game medium 12 includes logic to provide a game, denoted as game A, game B, and game C. In one embodiment, the game provided by game device 14 is an electronic video game. Games are each individually stored on media, such as compact disk read-only memories (CDROMs), digital versatile disks (DVDs), game cartridges, or other storage media such as Sony's proprietary Universal Media Disk (UMD). A game, such as game A, is inserted in, coupled to, or in communication with game device 14 so that game device 14 may read all or part of a game application and/or related game data found on game media 12. Some games might also be integrated in with game device 14, e.g., code may be stored as firmware such as on an ASIC or code may be stored in a fixed memory unit such as a hard drive or fixed ROM unit.

Game device 14 is a computing device that includes a processor, such as a CPU, and data storage combined or in separate elements. Game device 14 may be connected to a network that allows game device 14 to provide games that are not included on one or more game media 12. Thus, game A, game B, and game C may be accessed through the network and not be individually stored on game media 12. The network can be a LAN (local area network), WAN (wide area network), wireless network, point-to-point network, star network, token ring network, hub network, or other configuration. The most common type of network in current use is a TCP/IP (Transfer Control Protocol and Internet Protocol) network such as the global internetwork of networks often referred to as the “Internet” with a capital “I”. In certain network embodiments, a user system includes an HTTP client, e.g., a browsing program, that allows access to game programs over the network. To allow a user to select from a plurality of available games, a display 16 (e.g., monitor, LCD screen, TV screen, etc.) might present a list of the games provided by game applications on game media 12 or over a network.

A game application may be also referred to as a game code and/or a game program. A game application should be understood to include software code that game device 14 uses to provide a game for a user to play. A game application might comprise software code that informs game device 14 of processor instructions to execute, but might also include data used in the playing of the game, such as data relating to constants, images and other data structures created by the game developer. A user interacts with the game application and game device 14 through user input/output (I/O) devices.

FIG. 2 illustrates an embodiment of game device 14 according to the present invention. It should be understood that other variations of game device 14 may be substituted for the examples explicitly presented herein and may be appreciated by a person of skill in the art. As shown, game device 14 includes a processing unit 20 that interacts with other components of game device 14 and also components external to game device 14. A game media reader 22 is included that communicates with game media 12. Game media reader 22 may include a CDROM or DVD unit that reads a CDROM or DVD, or any other reader that can receive and read data from game media 12. One example is a unit in Sony's PSP for reading a UMD. Decoding features in game media reader 22 may be implemented in software, hardware or both.

Game device 14 might include a separate graphics processor 24. Game device 14 might be a handheld video game device, a console (special purpose) computing system for operating computer games such as video games, a general-purpose laptop or desktop computer, or other suitable system. Examples of game devices include special purpose devices such as Sony's Playstation 2®, Nintendo GameCube®, and Microsoft's XBox®, general purpose computers such as Apple PowerBooks and PowerMacs and other computers running Mac OSX or other UNIX based operating systems (OS) such as Linux, and laptops and PCs running MS Windows or Linux OS application, and hand held devices such as game-enable cell phones, Nintendo GameBoy®, Nintendo DS and Sony Playstation Portable (PSP).

Game device 14 also includes various components for enabling input/output, such as an I/O module 32, a user I/O module 34, a display I/O module 36, and a network I/O module 38. I/O module 32 interacts with storage element 40 and, through a device 42, removable storage media 44 in order to provide storage for game device 14. Processing unit 20 communicates through I/O module 32 to store data, such as game state data and any shared data files. In addition to storage 40 and removable storage media 26, game device 14 is also shown including ROM (read-only memory) 46 and RAM (random access memory) 48. RAM 48 may be used for data that is accessed frequently, such as when a game is being played.

User I/O module 34 is used to send and receive commands between processing unit 20 and one or more user input devices, such as game controllers, keyboards, mice, joysticks, etc. Display I/O module 36 provides input/output functions that are used to display images from the game being played on a display device. Network I/O module 38 is used for input/output functions for a network. For example, network I/O module 38 may be used if a game is being played on-line or being accessed on-line.

Game device 14 also includes other features that may be used with a game, such as a clock 50, flash memory 52, and other components. An audio/video player 56 might also be used to play a video sequence such as a movie. It should be understood that other components may be provided in game device 14 and that a person skilled in the art will appreciate other variations of game device 14.

Program code might be stored in ROM 46, RAM 48 or storage 40 (which might comprise hard disk, other magnetic storage, optical storage, other storage or a combination or variation of these. In a common arrangement, part of the program code is stored in ROM that is programmable (e.g., ROM, PROM, EPROM, EEPROM, etc.) and part of the program code is stored on removable media such as game media 12 (which can be a CD-ROM, cartridge, memory chip or the like, or obtained over a network or other electronic channel as needed). In general, program code can be found embodied in a tangible signal-bearing medium.

RAM 48 (and possibly other storage) is usable to store variables and other game and processor data as needed. Typically, RAM is used to hold data that is generated during the play of the game and portions thereof might also be reserved for frame buffers, game state and/or other data needed or usable for interpreting user input and generating game displays.

As game device 14 reads game media 12 and provides a game, information may be read from game media 12 and stored in a memory device, such as RAM 48. Additionally, data from storage 40, ROM 46, servers through a network (not shown), or removable storage media 26 may be read and loaded into RAM 48. Although data is described as being found in RAM 48, it will be understood that data does not have to be stored in RAM 48 and may be stored in other memory accessible to processing unit 20 or distributed among several media, such as game media 12 and storage 40.

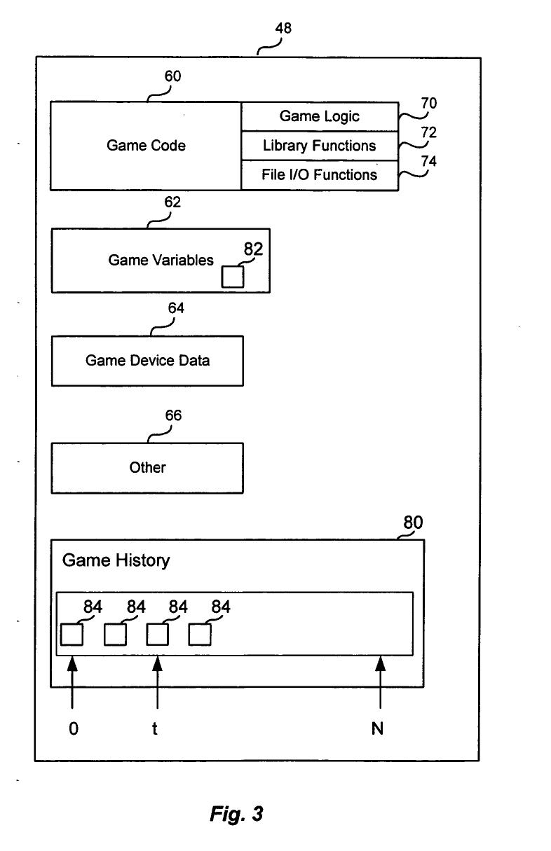

FIG. 3 illustrates an example of data that may be stored as game state and usable as part of a game history. In a simple case, game history comprises a recording of game display information for a replay period, and replaying is simply displaying the recorded game display information. In other cases, what is recorded is game data that can be used to regenerate the replayed game display. For example, in a baseball game, the specific actions of the players in the game during the recorded period (i.e., the period of actual game play prior to a game save event which is to be replayed following the loading of the saved game or resumption of a paused game) might be recorded along with indicia of ball location and play events and saved audio. In the latter case, upon replay, the game display would be regenerated from the saved data. The former case (storing display sequences) might be simpler for post-load processing, but might require more storage resources for the recorded display, whereas the latter case (saving game details and regenerating the display) can be stored more compactly, but would require processing resources during replay to regenerate the game display.

As shown in FIG. 3, game state might include game code 60, game variables 62, game device data 64, and other data 66 that may be downloaded from game media 12 and stored in RAM 48. It will be understood that a person of skill in the art will appreciate that other data may be stored in RAM 48 that will enable game device 14 to provide the game.

Game code 60 may include any logic that is found on game media 12 that is used to provide a game. Game code 60 includes game logic 70, library functions 72, and file I/O functions 74. Game logic 70 is used to provide any functions of the game. Library functions 72 include any functions that are used to provide a game. File I/O functions 74 are used by processing unit 20 to perform input/output functions.

Game variables 62 are variables that are specific to a game and are used by processing unit 20 to provide variations of games for different users. The variables allow game device 14 to provide variations to the game based on actions by a user playing the game.

Game device data 64 might include data specific to a game console for which the game code 60 is designed. For example, different versions of game code 60 may be designed for different platforms supported by different game devices 14. Data specifically needed to operate game code 60 on a specific platform for a specific game device 14 may be included in game device data 64. Other data 66 may be any other data that is used with the game.

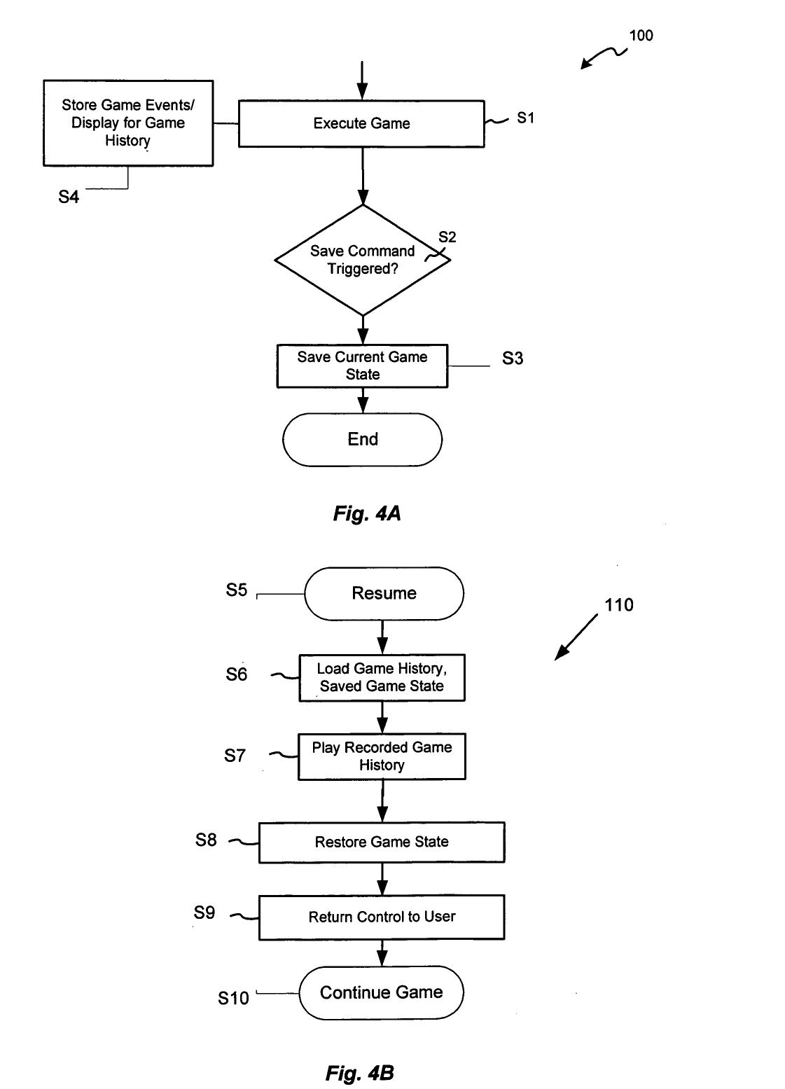

FIG. 4 illustrates a flowchart of a game replay process according to one embodiment. As shown in FIG. 4A, a process 100 for storing game history and game state data begins at step S1. As a game found on game media 12 is executed or played on game device 14, data regarding the state of the game and any other related aspects of the game may be generated. Upon receipt of a save command at step S2, the game state data is then stored in storage, such as storage 40, removable storage media 26, RAM 48, or any other storage media accessible to game device 14 in step S3. The save command may include a pause command or a terminate game command.

As the game is played, game history is concurrently recorded in step S4. Examples include recording game displays as they are presented (such as video frames displayed in order on a display) and/or recording data necessary to regenerate those displays (random seeds, user inputs, game state variables, animation variables, etc.).

The game state data may then be used at another time by game device 14 to provide a game that is in the same state as when a user last played the game and saved its state with the ability to reacquaint the user with the game as it was being played before the game was stopped (e.g., saved upon being stopped indefinitely or temporarily paused). It should be noted that the game state data does not necessarily start the game at the same exact place as the place when the game was last stopped but rather may start the game at a certain level or time related to when the game was last stopped or its state was saved.

As shown in FIG. 4B, a game resumption process 110 begins at step S10 in response to a resume game selection by a user. The resume game selection may include, for example, a selection from a menu of one or more saved games, selection of resume game in the case of a paused game, or the selection may be the result of a user turning on or loading a game that was shut down. In step S6, the saved game history and game state is reloaded or accessed by the processor and in step S7, a replay of the recorded game history is rendered on a display. During replay, it is preferred that users are not allowed to control aspects of the gameplay; users are unable to control or alter the saved game history and game state other than to perhaps speed up, slow down, pause, skip or restart the rendered replay sequences. In step S8 game state is restored to the point in the game at which game state was saved. In step S9, control of gameplay is returned to the user so that the user may resume playing the game in step S10.

Game history can be stored in RAM 48 (and then stored to storage 40 or other storage if power is to be removed from RAM 48). In network embodiments, game state and game history data can be stored on a server or locally on a user system. For example, in client-server embodiments, game state and history data can be stored at the game server, or it may be stored on the client device. An example memory data structure is shown in FIG. 3 as game history storage 80. As described herein, the user is provided with some amount of replay when a saved game is loaded and the amount can depend on one or more factors. In one set of examples, the length of the replay time is set at a number of seconds and that replay length, N, is stored as a game variable 82. Thus, where game variable game history 80 would include sufficient storage for N seconds of game history. As illustrated, game storage involves storing a number of snapshots 84 of game state (or merely display state, if that is how game history is recorded).

At the outset of a game, there is no history of course, so storage of game history can begin with a snapshot at “time=0” as shown by the “0” arrow. At a current time “t”, a snapshot would be recorded as shown by the “t” arrow. After N seconds have elapsed, as indicated by the “N” arrow, snapshot recording could cycle back and record over the oldest snapshots, thus forming a circular buffer. Other storage methods might be used instead.

The amount of time allowed for the replay can be set by the game designer, the user, the game at run-time depending on available storage, or according to other criteria. The amount of replayed game can be equal to all of the recorded game history, or it can be less than what was stored. Also, in certain aspects, during replay an on-screen countdown timer is provided to better prepare the user for the moment that user control of the game resumes. For example, a visual and/or audible display of a countdown sequence, e.g., “5” . . . “4” . . . “3” . . . “2” . . . “1” . . . “0”, may be rendered during playback. In certain aspects, a countdown feature may be implemented as any audio and/or visual indicator that indicates how much time is remaining until player control of the game resumes. Other examples include a shrinking bar on a display and/or an audible sequence.

Game history can be stored once for a game console, or multiple game histories can be stored. For example, each user of the console could have a separate game storage. Also, game history could be downloaded to a memory stick or other portable memory device and reloaded into the same game console or a different game console. Each user might have more than one game history, such as for different saved games and/or for different game modes. For example, a user might have one or more mid-game save shared between “Play Now” and “Challenges” modes, and one for each of the Season and Tournament save files. Mid-game saves may be based on a user request to save or pause a game at a specific point in time, or they may be automatically implemented by the game logic. For example, a mid game save may be performed automatically based on a timer or based on an important event occurring such as at halftime in a soccer game or when a goal is scored.

The user might be provided with an option to save a game with history from an active game using a button press to signal a desire to save a game or from a menu item, such as a “Pause Menu”. After saving, the user can resume play at any time after selecting pause, or the user can shut down the game device, console, computer, etc. and resume play later if desired.

The information saved as game history can vary from game to game. Not all of the information needed to perfectly replay the game need be saved. For example, during actual play of a soccer game, the position of all of the players on the field, whether visible on the display or not, might be tracked, but the saved game history might include only the movements of players that appear on the display during the history period (e.g., the time period to be replayed upon game resumption).

In a specific embodiment, the following information might be saved as game history for a computer simulated soccer game:

a. Game mode-specific data
1. Play Now settings
   1. Friendly
   2. Home and Away
      a. 1^{st} or 2^{nd} leg
      b. Score in 1^{st} leg if in 2^{nd} leg
      c. Bookings in first leg
2. Challenges Settings
   1. Challenge type (Comeback, Rout, Custom)
   2. Challenge number (Comeback, Rout) or details (Custom)
3. Season Settings
   1. Match date (or ID)
4. Tournament Settings
   1. Match date (or ID)

b. General data
1. ID of Home Team
2. ID of Away Team
3. Whether User is Home Team or Away Team
4. Current Time (including injury if already decided)
5. Current Score
6. Kits
7. Current Stadium Selection
8. Game event data
   1. Goals including Player Names and times
   2. Yellow cards with Player Names and times
   3. Red cards with Player Names and times
   4. Substitutions and any line-up changes
   5. Injuries
   6. Formations
   7. Tactics
   8. Match Facts (all stats)
9. Game settings
   1. Half length
   2. Difficulty
   3. Game Speed
   4. Injuries
   5. Off-sides
   6. Bookings
10. N second buffer of instant replay footage.

In another specific embodiment, resuming or loading a saved game (“Mid-Game Save”) occurs as follows:

1. Where a Mid-Game Save is restarted from depends on the mode in which it was saved:

a. Play Now and Challenges:
1. Upon loading a profile that contains a Mid-Game Save for Play Now or Challenges, the user is presented with an overlay asking them if they want to:
   1. RESUME GAME
   2. DELETE GAME
   3. CHANGE PROFILE

b. Season and Tournament
1. Upon loading a season or tournament file that contains a Mid-Game Save, the user is presented with an overlay asking them if they want to:
   1. RESUME GAME
   2. DELETE GAME
   3. CANCEL
      2. If the user selects “RESUME GAME”, they are shown a front end overlay (Confirm Mid-Game Save Start overlay) that describes the current situation, including score and time, and offered 2 options:

a. CONTINUE—loads into the back end

b. CANCEL—goes back to the previous Mid-Game Save Available overlay.

The way the Mid-Game Save restarts depends, in certain aspects, on the game situation where the save was made:

a. Normal Gameplay
1. Once a user choose to resume gameplay, e.g., pressing [X] on the resume screen, they are provided with a gameplay view where they see the last N seconds (or whatever length the replay period is determined to be) of play that lead up to the point where the game had been stopped by the user.
   1. While they are watching the lead-up replay, statistics overlays (showing key scores, for example) and a countdown timer are shown, possibly accompanied by a beeping audio signal preparing users for the moment when they take over control of the game.
   2. If the length of the replay available is less than the replay period (such as when the replay period is five seconds and less than five seconds of history was recorded because, for example, less than five seconds of the game were played before saving or for some other reason), then the user might be shown the first frame frozen at the start of the countdown until the replay footage can kick in.

b. Set-Piece (e.g., where the user saved a game during a game-related pause in the action; in soccer, for example, game-related pauses precede kick-offs, throw-ins, corners, free kicks, goal kicks, penalty kicks/shootouts, etc.)
2. Once the user presses a start key on a resume menu (or other input), they are shown a view of the set piece spot where the mid-game save occurred. While the game appears still, the statistics header and/or footer and countdown timer may be shown, possibly accompanied by the audio signal.
3. In some game configurations, no matter how much set-piece set-up time the user had wasted before the mid-game save occurred, when reloaded they will be given the full set-time to execute their set-piece.

c. Half-time, full-time, extra time half-time, extra time full-time
4. Once the user resumes play, the history indicia are shown and the user is provided with a view of the kick-off that follows the break when the mid-game save occurred. While the game appears still, the statistics header and/or footer and countdown timer may be shown, possibly accompanied by the audio signal.

In each case, the change between the replay and regaining control should be seamless, except that any visual countdown timer goes away, the statistics header and/or footer, if present, slide off the screen, the normal game audio resumes possibly with a quick fade in from the game history audio (and any countdown audio signal stops or fades out), and the user regains control of the game action. Thus, in one aspect, once the user regains control, the history indicia (timer, etc.) go away, normal game audio resumes and the user regains control of the action. Other transition effects might be included as needed. As one example, the screen could flash (e.g., one or more white flashes) at about the time the player control resumes. Also, if the player is using a user input device that implements force-feedback, or haptic, technology, a signal could be sent to the input device to alert the user that player control has resumed.

In some configurations, current game state will override the game state provided in the game history. For example, if the user changed the color of the field, the score or other statistics or game variable prior to resumption, those changes might take precedence over game history. Thus, if the stadium was Stadium A when the game history was recorded (prior to game save), but the user later changed the stadium to Stadium B, then the game replay after resumption would replay the game history showing Stadium B. Naturally, some of the details of game history would not be changeable in order to present a sensible game history replay. For example, the stored game history might take precedence as to the locations of players so that the game history replayed provides the user with “reacquaintance” with the saved game.

Since the game history is already determined when the game is resumed and the saved game loaded, the user would normally not be able to alter the game play during the replay period. One way to do that is for the game system to ignore all user inputs. Of course, where it makes sense, the game system can accept some user input whether or not it is expected and take appropriate action. User input during game history replay that might be useful includes fastforward, reverse, pause, etc., where the user desires more or less reacquaintance with the game history.

In certain instances, there can be more than one user who uses the same game device with a different or the same memory storage device (such as internal memory or removable memory). Where two or more users use the same game device, each user's preference and history information is preferably stored separately.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer game system including a user input module for receiving user input, at least one processor, and a display output module for outputting a game display, wherein the output game display is at least in part dependent upon the received user input, the game system comprising:
game history storage for storing game events over a finite, nonzero time span;
means for replaying a game history using the stored game events upon loading of a saved game or resumption of a paused game and prior to turning over control of the game to the user.

2. The game system of claim 1, wherein the game is a video game and the stored game history comprises a stored video and/or audio sequence representing game events from a nonzero time period prior to the game being saved or paused.

3. The game system of claim 1, further including means for displaying a visual and/or audible countdown indicator concurrent with a game history replay.

4. The game system of claim 1, wherein the game system is implemented in a game server communicably coupled to one or more client devices over a network, wherein each client device includes one or more user input devices for providing the user input and a display for displaying the output game display.

5. The game system of claim 1, wherein the game system is implemented in a stand alone device including one or more user input devices for providing the user input and a display for displaying the output game display.

6. A computer-implemented method of refamiliarizing a user with game events occurring during gameplay of a computer game prior to a restart of a saved game configuration, the method comprising:
storing game events over a finite, nonzero time span during gameplay;
receiving an instruction to save gameplay;
in response to an instruction to resume gameplay, replaying at least a portion the stored game events on a display without allowing user input control of gameplay; and immediately thereafter
returning game control to the user and resuming gameplay.

7. The method of claim 6, wherein the instruction to save includes a user request to pause gameplay of the game.

8. The method of claim 7, wherein the instruction to resume includes a user request to resume gameplay of the paused game.

9. The method of claim 6, wherein the instruction to save includes a user request to shut down or terminate the game.

10. The method of claim 9, wherein the instruction to resume includes a request to reload the saved game.

11. The method of claim 6, further including displaying a visual and/or audible countdown indicator concurrently with the stored game events being replayed on the display.

12. The method of claim 6, wherein the game is a video game and the stored game history comprises a stored video and/or audio sequence representing game events from a nonzero time period prior to gameplay being stopped.

13. The method of claim 6, implemented in a network environment including a game server and at least one client system.

14. The method of claim 6, implemented in a stand alone device coupled to or including one or more user input devices and the display.

15. A computer readable medium including code for controlling a processor to refamiliarize a user with game events occurring during gameplay of a computer game prior to a restart of a saved game configuration, the code including instructions to:
store game events over a finite, nonzero time span during gameplay;
receive a command to save gameplay;
in response to a command to resume gameplay, replay at least a portion the stored game events on a display without allowing user input control of gameplay; and
immediately thereafter return game control to the user and resume gameplay.

16. The computer readable medium of claim 15, wherein the command to save is based on a user request to pause gameplay of the game, and wherein the command to resume is based on a user request to resume gameplay of the paused game.

17. The computer readable medium of claim 15, wherein the command to save is based on a user request to shut down or terminate the game, and wherein the command to resume is based on a user request to reload the saved game.

18. The computer readable medium of claim 15, wherein the code further includes instructions to display a visual and/or audible countdown indicator concurrently with the stored game events being replayed on the display.

19. The computer readable medium of claim 15, wherein the game is a video game and the stored game history comprises a stored video and/or audio sequence representing game events from a nonzero time period prior to gameplay being stopped.

20. The computer readable medium of claim 15, wherein the processor is integrated in a game server communicably coupled to one or more client devices over a network, wherein each client device is coupled to or includes the display and one or more user input devices for providing user input.

21. The computer readable medium of claim 15, wherein the processor is integrated in a stand alone device coupled to or including the display and one or more user input devices for providing user input.

22. The computer readable medium of claim 15, implemented in one of a game cartridge, a CDROM, a UMD or a DVD.

23. The computer readable medium of claim 15, wherein the game is a video game and the stored game history comprises game variables that are used to reconstruct video and/or audio sequences representing game events from a nonzero time period prior to gameplay being stopped.

24. The system of claim 1, wherein the game is a video game and the stored game history comprises game variables that are used to reconstruct video and/or audio sequences representing game events from a nonzero time period prior to gameplay being saved or paused.

25. The method of claim 6, wherein the game is a video game and the stored game history comprises game variables that are used to reconstruct video and/or audio sequences representing game events from a nonzero time period prior to gameplay being stopped.

26. The method of claim 6, wherein the instruction to save is automatically generated in response to a certain event occurring or after a certain amount of time during gameplay.

27. The method of claim 26, wherein the instruction to resume is automatically generated.

28. The computer readable medium of claim 15, wherein the command to save is automatically generated in response to a certain event occurring or after a certain amount of time during gameplay.

29. The computer readable medium of claim 28, wherein the command to resume is automatically generated.
